(19) United States
(12) Patent Application Publication
(10) Pub. No.: US 2023/0047323 A1
(43) Pub. Date: Feb. 16, 2023

(54) METAL PHOSPHOROTHIOATES AND METAL-SULFUR ELECTROCHEMICAL SYSTEM CONTAINING THE SAME

(71) Applicant: THE TRUSTEES OF DARTMOUTH COLLEGE, Hanover, NH (US)

(72) Inventors: Chuanlong WANG, Hanover, NH (US); Weiyang LI, Hanover, NH (US)

(21) Appl. No.: 17/790,245

(22) PCT Filed: Dec. 31, 2020
(86) PCT No.: PCT/US20/67713

§ 371 Date: Jun. 30, 2022

Related U.S. Application Data
(60) Provisional application No. 62/956,428, filed on Jan. 2, 2020.

(51) Int. Cl. H01M 4/58; H01M 10/0562; H01M 10/0525; H01M 4/62

(52) U.S. Cl. CPC H01M 4/5815; H01M 10/0562; H01M 10/0525; H01M 4/625; H01M 2004/027

(57) ABSTRACT

The disclosure relates to metal phosphorothioates, batteries comprising metal phosphorothioate, cells comprising metal phosphorothioate, and methods of making thereof.

### CROSS-REFERENCE TO RELATED APPLICATIONS

This application claims priority to U.S. Provisional Patent Application No. 62/956,428, filed Jan. 2, 2020, which is incorporated herein by reference in its entirety.

### GOVERNMENT RIGHTS

The invention was made with government support under Grant No. FA9550-17-1-0184 by US Air Force Office of Scientific Research and Grant No. 80NSSC18K1514 by NASA's Space Technology Research Grants Program. The government has certain rights in the invention.

### BACKGROUND

Lithium (Li)-ion batteries (LIBs) have transformed multiple industries since the 1990s, ranging from portable electronics to electric-powered transportation. However, conventional LIBs may be improved to increase their capacity, extend their life span and/or to lower their manufacturing cost.

### SUMMARY

The present disclosure provides a metal phosphorothioate having the formula of cP₂S₅-dM₂S_{z}, wherein: the metal (M) is lithium or sodium; the ratio of P₂S₅ to M₂S_{z} (c:d) is between 1:2 and 2:1, optionally the ratio of P₂S₅ to M₂S_{z} (c:d) is 1:2, 2:3, 1:1, 3:2, or 2:1; and z is an integer from 1 to 12.

In some embodiments, the metal is sodium. In some embodiments, c:d is 1:1. In some embodiments, z is 8. In some embodiments, z is 1.

The present disclosure also provides a method of preparing a metal phosphorothioate of the disclosure, the method comprising: mixing a stoichiometric ratio of metal sulfide (M₂S), phosphorous pentasulfide (P₂S₅) and sulfur (S) powder in an organic solvent.

In some embodiments, the cP₂S₅-dM₂S_{z} complex is formed by mixing the metal sulfide (M₂S) and the sulfur (S) powder in the organic solvent to provide a metal polysulfide (M₂S_{y}); and combining the metal polysulfide (M₂S_{y}) with the phosphorous pentasulfide (P₂S₅) to form the cP₂S₅-dM₂S_{z} complex. In another embodiment, the cP₂S₅-dM₂S_{z} complex is formed via a one-step reaction by mixing the stoichiometric ratio of the metal sulfide (M₂S), the phosphorous pentasulfide (P₂S₅), and the sulfur (S) powder in the organic solvent. In some embodiments, the organic solvent is diglyme. In some embodiments, the metal phosphorothioate is prepared at room temperature.

The present disclosure also provides a metal (M)-sulfur battery comprising: a cathode comprising an mP₂S₅-nM₂Sₓ complex; an anode comprising the metal, wherein the metal is passivated using an anode passivation solution comprising an aP₂S₅-bM₂S_{y} complex; and an electrolyte in contact with the cathode and the anode; wherein the metal (M) is lithium or sodium; wherein the ratio of P₂S₅ to M₂Sₓ (m:n) in the cathode is between 1:2 and 2:1, optionally the ratio of P₂S₅ to M₂Sₓ (m:n) in the cathode is 1:2, 2:3, 1:1, 3:2, or 2:1; wherein the ratio of P₂S₅ to M₂S_{y} (a:b) in the anode passivation solution is between 1:2 and 2:1, optionally the ratio of P₂S₅ to M₂S_{y} (a:b) in the anode passivation solution is 1:2, 2:3, 1:1, 3:2, or 2:1; and wherein x and y are independently an integer from 1 to 12.

In some embodiments, M is sodium. In some embodiments, m:n is 1:1. In some embodiments, a:b is 1:1. In some embodiments, x is 8. In some embodiments, y is 1. In some embodiments, the battery further comprises a solid electrolyte interphase (SEI) on the anode, wherein the SEI mainly comprises Na₄P₂S₇, Na₄P₂S₆, Na₂P₂S₆, Na₃PS₄ and NaPS₃. In some embodiments, the electrolyte comprises NaPF₆ in diglyme. In some embodiments, the battery further comprising a separator, wherein the separator keeps the cathode and the anode apart. In some embodiments, the battery is rechargeable. In some embodiments, the cathode is a liquid-phase cathode.

The present disclosure also provides a metal (M)-sulfur cell comprising: a cathode comprising an mP₂S₅-nM₂Sₓcomplex; an anode comprising the metal, wherein the metal is passivated using an anode passivation solution comprising an aP₂S₅-bM₂S_{y} complex; and an electrolyte in contact with the cathode and the anode; wherein the metal (M) is lithium or sodium; wherein the ratio of P₂S₅ to M₂Sₓ (m:n) in the cathode is between 1:2 and 2:1, optionally the ratio of P₂S₅ to M₂Sₓ (m:n) in the cathode is 1:2, 2:3, 1:1, 3:2, or 2:1; wherein the ratio of P₂S₅ to M₂S_{y} (a:b) in the anode passivation solution is between 1:2 and 2:1, optionally the ratio of P₂S₅ to M₂S_{y} (a:b) in the anode passivation solution is 1:2, 2:3, 1:1, 3:2, or 2:1; and wherein x and y are independently an integer from 1 to 12.

The present disclosure also provides a manufacturing a metal (M)-sulfur cell comprising: mixing a first stoichiometric ratio of metal sulfide (M₂S), phosphorous pentasulfide (P₂S₅) and sulfur (S) powder in a first organic solvent to form the aP₂S₅-bM₂S_{y} complex; contacting a metal foil with the aP₂S₅-bM₂S_{y} complex to form the passivated anode; mixing a second stoichiometric ratio of metal sulfide (M₂S), phosphorous pentasulfide (P₂S₅) and sulfur (S) powder in a second organic solvent to form the mP₂S₅-nM₂Sₓ complex; mixing the mP₂S₅-nM₂Sₓ complex with electro-conductive carbon black and a salt to form the cathode; and contacting the electrolyte with the passivated anode and the cathode.

In some embodiments, the aP₂S₅-bM₂S_{y} complex is formed by mixing the metal sulfide (M₂S) and the sulfur (S) powder in the first organic solvent to provide a metal polysulfide (M₂S_{y}); and combining the metal polysulfide (M₂S_{y}) with the phosphorous pentasulfide (P₂S₅) to form the aP₂S₅-bM₂S_{y} complex. In some embodiment, the aP₂S₅-bM₂S_{y} complex is formed via a one-step reaction by mixing the first stoichiometric ratio of the metal sulfide (M₂S), the phosphorous pentasulfide (P₂S₅), and the sulfur (S) powder in the first organic solvent.

In some embodiments, the mP₂S₅-nM₂Sₓ complex is formed by mixing the metal sulfide (M₂S) and the sulfur (S) powder in the second organic solvent to provide a metal polysulfide (M₂Sₓ); and combining the metal polysulfide (M₂Sₓ) with the phosphorous pentasulfide (P₂S₅) to form the mP₂S₅-nM₂Sₓ complex. In some embodiments, the mP₂S₅-nM₂Sₓ complex is formed via a one-step reaction by mixing the second stoichiometric ratio of the metal sulfide (M₂S), the phosphorous pentasulfide (P₂S₅), and the sulfur (S) powder in the second organic solvent.

In some embodiments, the first organic solvent and the second organic solvent are the same. In some embodiments, the first organic solvent and the second organic solvent are different. In some embodiments, the first and second organic solvents may be independently selected from the following group of solvents, shown here by way of example but not intended to limit other examples, diethylene glycol dimethyl ether (diglyme), 1,2-dimethoxyethane (DME), tetrahydrofuran (THF), 1,3-dioxolane (DOL), tetraethylene glycol dimethyl ether, or a combination thereof. In some embodiments, the aP₂S₅-bM₂S_{y} complex and the mP₂S₅-nM₂Sₓ complex are formed at room temperature.

### BRIEF DESCRIPTION OF THE DRAWINGS

FIG. 1A is a depiction of a sodium battery of the disclosure.

FIG. 1B is a photograph of traditional Na₂Sₓ and P₂S₅—Na₂Sₓ (x=1, 2, 3, 4, 6, 8) complexes along with mP₂S₅-nNa₂S₈ (m:n=1:2, 2:3, 1:1, 3:2, 2:1) complexes.

FIG. 1C is a photo of mP₂S₅-nNa₂S complexes in diglyme solvent.

FIG. 1D is a photo of mP₂S₅-nNa₂S₃ complexes in diglyme solvent.

FIG. 2A is a ³¹P-NMR spectrum of P₂S₅—Na₂Sₓ (x=1, 2, 3, 4, 6, 8) and mP₂S₅-nNa₂S₈ (m:n=2:3, 1:1, 3:2) complexes in diglyme solvent.

FIG. 2B is a Raman spectrum of P₂S₅—Na₂Sₓ (x=1, 2, 3, 4, 6, 8) and mP₂S₅-nNa₂S₈ (m:n=1:1, 3:2) complexes in diglyme solvent.

FIG. 2C are Raman profiles of P₂S₅, S, and Na₂S powders, and diglyme.

FIG. 3 is a ³¹P-NMR spectrum of P₂S₅—Na₂S₈ in THF, diglyme, and DME solvents.

FIG. 4A is an ¹H-NMR spectrum of P₂S₅—Na₂S₈ in diglyme.

FIG. 4B is an ¹H-NMR spectrum of P₂S₅—Na₂S₈ in DME.

FIG. 4C is an ¹H-NMR spectrum of P₂S₅—Na₂S₈ in THF.

FIG. 5 is a comparison of the ³¹P-NMR spectra of the P₂S₅—Na₂S₈ complex in diglyme taken within one day and after 30 days of storage.

FIG. 6 is a cyclic voltammetry trace of cells consisting of P₂S₅—Na₂Sₓ (x=1, 2, 3, 4, 6, 8) as catholyte paired with passivated Na at a scan rate of 0.10 mV s⁻¹ within the voltage range of 1.2-2.4 V.

FIG. 7A is a cyclic voltammetry trace of cells consisting of P₂S₅—Na₂S₈ and Na₂S₈ as catholyte paired with passivated Na as anode at different scanning rates of 0.10, 0.15 and 0.20 mV s⁻¹ in the voltage ranges of 1.2-2.4 V.

FIG. 7B is a cyclic voltammetry trace of cells consisting of P₂S₅—Na₂S₈ and Na₂S₈ as catholyte paired with passivated Na as anode at different scanning rates of 0.10, 0.15 and 0.20 mV s⁻¹ in the voltage ranges of 1.8-2.4 V.

FIG. 8 is a set of graphs depicting cyclic voltammetry peak current against the square root of scan rates for the anodic reaction (at ˜2.32 V) and the cathodic reaction (at ˜2.23 V).

FIG. 9A is a set of typical galvanostatic charge curves of the P₂S₅—Na₂S₈ and Na₂S₈ catholyte cells at 0.5 C (1 C=1675 mA g⁻¹) over the voltage range from 1.2 V to 2.4 V.

FIG. 9B is a galvanostatic discharge curve of the P₂S₅—Na₂S₈ and Na₂S₈ catholyte cells at 0.5 C (1 C=1675 mA g⁻¹) within the voltage range of 1.2-2.4 V.

FIG. 10A is a Raman profile at 2.4, 1.8 and 1.2 V for P₂S₅—Na₂S₈ catholyte cell.

FIG. 10B is a Raman profile at 2.4 V for Na₂S₈ catholyte cells cycled at 0.5 C (1 C=1675 mA g⁻¹).

FIG. 11 is a graph depicting the galvanostatic cycling performance of cells consisting of P₂S₅—Na₂S₈ and Na₂S₈ as catholyte paired with passivated Na at 0.5 C (1 C=1675 mA g⁻¹) within the voltage ranges of 1.8-2.4 V and 1.2-2.4 V.

FIG. 12 is a graph depicting the galvanostatic cycling performance of cells consisting of P₂S₅ suspension as catholyte (same S concentration based on S in P₂S₅) paired with passivated Na at 0.5 C (1 C=1675 mA g⁻¹) within the voltage range of 1.2-2.4 V.

FIG. 13 is a graph depicting the Coulombic efficiency of cells consisting of P₂S₅—Na₂S₈ and Na₂S₈ as catholyte paired with passivated Na as anode at 0.5 C (1 C=1675 mA g⁻¹) within the voltage ranges of 1.8-2.4 V and 1.2-2.4 V.

FIG. 14 is a graph evaluating the electrochemical cycling at different rates of 0.25 C, 0.5 C and 0.75 C (1 C=1675 mA g⁻¹) for P₂S₅—Na₂S₈ catholyte cells within the voltage range of 1.8-2.4 V.

FIG. 15 is a graph depicting cycling performance of P₂S₅—Na₂S₈ catholytes over a range of active sulfur material loadings.

FIG. 16 is an electrochemical impedance spectrum of the P₂S₅—Na₂S₈ catholyte cells before cycling and after 50, 100, and 200 cycles at 0.5 C within the voltage range of 1.8-2.4 V and 1.2-2.4 V.

FIG. 17 is a set of scanning electron microscope image of the passivated Na surfaces of the P₂S₅—Na₂S₈ and the Na₂S₈ catholyte cells after 30 cycles.

FIG. 18 is a set of X-ray photoelectron spectra of (a) C₁ₛ, (b) P₂ₚ and (c) S₂ₚ on the passivated Na surface before cycling.

FIG. 19 is set of X-ray photoelectron spectra of C₁ₛ, P₂ₚ and S₂ₚ on the passivated Na surface for the P₂S₅—Na₂S₈ and Na₂S₈ catholyte cells after 30 cycles.

FIG. 20A is an X-ray diffractogram of P₂S₅—Na₂SₓP₂S₅—Na₂S₃ and P₂S₅—Na₂S₈ passivated Na.

FIG. 20B is a Raman spectrum of P₂S₅—Na₂SₓP₂S₅—Na₂S₃ and P₂S₅—Na₂S₈ passivated Na.

FIG. 21A is a graph depicting the galvanostatic cycling performance of cells consisting of P₂S₅—Na₂S₈ as catholyte paired with P₂S₅—Na₂S₈ passivated at 0.5 C (1 C=1675 mA g⁻¹) within the voltage range of 1.8-2.4 V.

FIG. 21B is a graph depicting the coulombic of cells consisting of P₂S₅—Na₂S₈ as catholyte paired with P₂S₅—Na₂S₈ passivated Na as anode at 0.5 C (1 C=1675 mA g⁻¹) within the voltage range of 1.8-2.4 V.

### DETAILED DESCRIPTION

In one aspect, the present disclosure provides a metal (M)-sulfur battery including a cathode including an mP₂S₅-nM₂Sₓcomplex; an anode including the metal, wherein the metal is passivated/pretreated using an aP₂S₅-bM₂S_{y} complex; and an electrolyte in contact with the cathode and the anode; wherein the metal (M) is lithium or sodium; wherein the ratio of P₂S₅ to M₂Sₓ (m:n) in the cathode is various within a range from 1:2 to 2:1 (such as but not limited to 1:2, 2:3, 1:1, 3:2, or 2:1); wherein the ratio of P₂S₅ to M₂S_{y} (a:b) in the passivation solution is various within a range from 1:2 to 2:1 (such as but not limited to 1:2, 2:3, 1:1, 3:2, or 2:1); wherein x and y are independently an integer from 1 to 12.

In one embodiment, the metal is sodium. In another embodiment, m:n is 1:1. In another embodiment, a:b is 1:1. In another embodiment, x is 8. In another embodiment, y is 1. In another embodiment, the battery further includes a solid electrolyte interphase (SEI) on the passivated anode, wherein the SEI mainly includes Na₄P₂S₇, Na₄P₂S₆, Na₂P₂S₆, Na₃PS₄ and NaPS₃. In another embodiment, the SEI comprises one, two, three, or four compounds selected from the group consisting of Na₄P₂S₇, Na₄P₂S₆, Na₂P₂S₆, Na₃PS₄ and NaPS₃. In another embodiment, the electrolyte includes NaPF₆ in diglyme. In another embodiment, the battery further includes a separator, wherein the separator keeps the cathode and the anode apart. In another embodiment, the battery is rechargeable. In another embodiment, the cathode is in the liquid phase.

In another aspect, the present disclosure provides a metal (M)-sulfur cell including a cathode including an mP₂S₅-nM₂Sₓcomplex; an anode including the metal, wherein the metal is passivated/pretreated using an aP₂S₅-bM₂S_{y} complex; and an electrolyte in contact with the cathode and the anode; wherein the metal (M) is lithium or sodium; wherein the ratio of P₂S₅ to M₂Sₓ (m:n) in the cathode is various within a range from 1:2 to 2:1 (such as but not limited to 1:2, 2:3, 1:1, 3:2, or 2:1); wherein the ratio of P₂S₅ to M₂S_{y} (a:b) is various within a range from 1:2 to 2:1 (such as but not limited to 1:2, 2:3, 1:1, 3:2, or 2:1); wherein x and y are independently an integer from 1 to 12.

In another aspect, the present disclosure provides a method of manufacturing the metal (M)-sulfur battery or cell disclosed herein including the steps of mixing an appropriate stoichiometric ratio of metal sulfide (M₂S), phosphorous pentasulfide (P₂S₅) and sulfur (S) powder in an organic solvent to form the aP₂S₅-bM₂S_{y} complex; contacting a metal foil with the aP₂S₅-bM₂S_{y} complex to form the passivated anode; mixing an appropriate stoichiometric ratio of metal sulfide (M₂S), phosphorous pentasulfide (P₂S₅) and sulfur (S) powder in an organic solvent to form the mP₂S₅-nM₂Sₓ complex; mixing the mP₂S₅-nM₂Sₓ complex with electro-conductive carbon black and a salt to form the cathode; and contacting the electrolyte with the passivated anode and the cathode. In some embodiments, the aP₂S₅-bM₂S_{y} complex can be formed in two steps: i) mixing metal sulfide (M₂S) and sulfur (S) powder in an organic solvent to provide a metal polysulfide (M₂S_{y}); ii) combining the metal polysulfide (M₂S_{y}) with phosphorous pentasulfide (P₂S₅) in a stoichiometric ratio to form the aP₂S₅-bM₂S_{y} complex. In some embodiments, the aP₂S₅-bM₂S_{y} complex can be formed in two steps: i) mixing phosphorous pentasulfide (P₂S₅) and metal sulfide (M₂S) powder in a stoichiometric ratio in an organic solvent to provide the aP₂S₅-bM₂S; adding a suitable amount of sulfur (Sₙ, n=y−1) into aP₂S₅-bM₂S to form the aP₂S₅-bM₂S_{y} complex. In some embodiments, the aP₂S₅-bM₂S_{y} complex can be formed via a one-step reaction by mixing appropriate the stoichiometric ratio of metal sulfide (M₂S), phosphorous pentasulfide (P₂S₅) and sulfur (S) powder in an organic solvent.

In some embodiments, the metal foil is a lithium foil. In preferred embodiments, the metal foil is a sodium foil.

In some embodiments, the salt is selected from the group consisting of lithium perchlorate (LiClO₄), lithium hexafluorophosphate (LiPF₆), lithium borofluoride (LiBF₄), lithium bis(trifluoromethanesulfonyl)imide (LiTFSI), lithium bis(fluorosulfonyl)imide (LiFSI), lithium triflouromethanesulfonate (LiOTf), sodium perchlorate (NaClO₄), sodium borofluoride (NaBF₄), sodium hexafluorophosphate (NaPF₆) sodium bis(trifluoromethanesulfonyl)imide (NaTFSI), sodium bis(fluorosulfonyl)imide (NaFSI) and sodium triflouromethanesulfonate (NaOTf). In some embodiments, the salt is NaPF₆.

In some embodiments, the organic solvent comprises diethylene glycol dimethyl ether (diglyme), 1,2-dimethoxyethane (DME), tetrahydrofuran (THF), 1,3-dioxolane (DOL), tetraethylene glycol dimethyl ether (TEGDME), or a combination thereof. In some embodiments, the organic solvent is a unary system (one solvent) and is selected from the group consisting of diglyme, DME, THF, DOL, and TEGDME. In some embodiments, the organic solvent is a mixture of two or three or four solvents selected from the group consisting of diglyme, DME, THF, DOL and TEGDME. Exemplary binary solvent (two solvent) systems include, but are not limited to, diglyme/THF, diglyme/DOL, DME/THF, DME/DOL, TEGDME/THF and TEGDME/DOL, wherein the two components are present in a volume ratio from 1:9 to 9:1. In some embodiments, the aP₂S₅-bM₂S_{y} complex and the mP₂S₅-nM₂Sₓ complex are formed at room temperature. In some embodiments, the aP₂S₅-bM₂S_{y} complex and the mP₂S₅-nM₂Sₓ complex are formed under heated conditions. In some embodiments, the concentration of the aP₂S₅-bM₂S_{y} complex and the mP₂S₅-nM₂Sₓ complex in the organic solvent does not exceed 50 wt %. In some embodiments, the concentration of the aP₂S₅-bM₂S_{y} complex and the mP₂S₅-nM₂Sₓ complex in the organic solvent is 20 wt %. In some embodiments, the aP₂S₅-bM₂S_{y} complex and the mP₂S₅-nM₂Sₓ complex are chemical stability in the solvent for a period of at least one month, at least two months, at least three months, at least four months, at least five months, or at least six months. In some embodiments, the aP₂S₅-bM₂S_{y} complex and the mP₂S₅-nM₂Sₓ complex are chemical stability in the solvent for a period of at least one month.

In some embodiments, the present disclosure provides a metal phosphorothioate having the formula of cP₂S₅-dM₂S_{z}, wherein the metal (M) is lithium or sodium; the ratio of P₂S₅ to M₂S_{z} (c:d) is various within a range from 1:2 to 2:1 (such as but not limited to 1:2, 2:3, 1:1, 3:2, or 2:1); and z is an integer from 1 to 12. In some embodiments, the metal is sodium. In another embodiment, c:d is 1:1. In another embodiment, z is 8. In another embodiment, z is 1.

In another aspect, the present disclosure provides a method of preparing the metal phosphorothioate disclosed herein including the steps of mixing an appropriate stoichiometric ratio of metal sulfide (M₂S), phosphorous pentasulfide (P₂S₅) and sulfur (S) powder in an organic solvent. In some embodiments, the organic solvent is diethylene glycol dimethyl ether (diglyme). In another embodiment, the metal phosphorothioate is prepared at room temperature.

In some embodiments, the present disclosure provides a catholyte (liquid-phase cathode) including active materials (i.e., the phosphorothioates disclosed herein), conductive agents (such as carbon black or ketjen black) and sodium salts (such as sodium hexaflourophosphate).

In another embodiment, the present disclosure provides active materials (i.e., sodium/lithium phosphorothioates) which could be synthesized through complexation reactions among sodium/lithium sulfide, sulfur and phosphorous pentasulfide in the corresponding stoichiometric ratio in solvents (such as diethylene glycol dimethyl ether, 1,2-dimethoxyethane or tetrahydrofuran) without external heating process.

In another embodiment, the present disclosure provides a passivation solution which can effectively generate solid electrolyte interphase (SEI) on sodium/lithium metal anode to stabilize battery performance.

In some embodiments, the present disclosure provides sodium/lithium phosphorothioate species, which may be employed as a catholyte for room temperature sodium/lithium batteries. In some embodiments, synthesis of the sodium/lithium phosphorothioates is low-cost without the need for external heating process. In some embodiments, the sodium/lithium phosphorothioates may be used as a catholyte for sodium/lithium sulfur batteries, and show superior electrochemical performance.

In some embodiments, the present disclosure provides a method of using the sodium/lithium phosphorothioates as a catholyte for sodium/lithium sulfur batteries, which may prevent precipitation of low-order sodium/lithium polysulfide, stabilize the metallic anode, and lead to highly-stable long-term battery cycling. In some embodiments, using the sodium/lithium phosphorothioates as a catholyte may provide a higher sodium/lithium-ion diffusion rate, improve electrochemical kinetics, and lead to high-rate performance. In some embodiments, using the sodium/lithium phosphorothioates as a catholyte may provide significantly enhanced electrochemical potentials and facilitate high energy/power density. In some embodiments, using the sodium/lithium phosphorothioates as passivation solution to metal anode may effectively alleviate side reactions and enhance stability of metallic sodium/lithium performance.

In some embodiments, using the sodium/lithium phosphorothioates as a catholyte may enable sodium/lithium-sulfur electrochemistry, which may enhance energy density, stabilize long-term cycling, and reduce energy cost compared to current lithium-ion technologies. In some embodiments, using the sodium/lithium phosphorothioates as a catholyte may enable a much faster voltage rise in charge processes and thus a better Coulombic efficiency behavior compared to traditional sodium/lithium-sulfur system. In some embodiments, using the sodium/lithium phosphorothioates as a catholyte may enable higher active-sulfur loadings simply by using a higher concentration of the mP₂S₅-nM₂Sₓcomplex and/or adding a larger volume of the complex solution on carbon current collector.

The present disclosure provides a new series of sodium phosphorothioates via the interaction between sodium polysulfide (Na₂Sₓ) and phosphorothioates, where Sₓ chains of different lengths are interconnected by phosphorothioate derivatives, forming uniform soluble species. The present disclosure provides sodium phosphorothioates with a longer Sₓ chain, which possess higher reactivity, and could serve as catholytes (liquid-phase cathode) for Na batteries. Phosphorothioates with short Sₓ chains (i.e., those with low “x” values), though possessing no electrochemical reactivity, can generate an effective solid electrolyte interphase (SEI) on metallic Na, which would result in a highly reactive anode and requires protection from direct contact with electrolytes/polysulfides to alleviate side reactions in Na batteries.

The present disclosure provides a novel Na battery electrochemistry with a greatly reactive catholyte and a pretreated Na anode, which solves intrinsic issues of the presence of unanchored reactive intermediate polysulfides, the formation of undissolved discharged sulfides and the repeated liquid-solid phase transition. By addressing the above issues, the batteries disclosed herein exhibit superior electrochemical performance of an initial capacity of 440 mAh g⁻¹ with a high retention of 80% even after over 400 cycles. The sodium phosphorothioates disclosed herein provide batteries with high energy, low cost and long lifespan.

Comprehensive characterization tools, such as nuclear magnetic resonance (NMR), Raman, scanning electron microscope (SEM), energy dispersive X-ray spectroscopy (EDS) and X-ray photoelectron spectroscopy (XPS), were employed to investigate the molecular structure and chemistry involved in the molecules and complexes disclosed herein. In some embodiments, the present disclosure provides molecules/complexes which possess short-range order phosphorous groups connected with sulfur chain in different lengths due to different mixing molar ratios.

Electrochemical evaluations, such as cyclic voltammetry (CV), galvanostatic charge-discharge, long-term cycling and electrochemical impedance spectroscopy (EIS), were performed to investigate electrochemistry and demonstrate high-performance sodium/lithium sulfur battery applications. Sodium/lithium sulfur electrochemistry was identified, and the mechanism of superior electrochemical performance was revealed.

In another aspect, sodium (Na), as used in the present disclosure, possesses certain chemical/physical properties similar to Li, but Na also has several advantages over Li. By way of example, Na's first ionization energy of 495.8 kJ mol⁻¹ is lower than that of Li (520.2 kJ mol⁻¹), leading to improved kinetics in chemical reactions. As an earth-abundant element, Na is over 1000 times more abundant than Li in the earth crust. The cost of Na raw materials (carbonate salt) is more than 100 times less expensive than that of Li.

### EXAMPLES

### Example 1

### A New Family of Sodium Phosphorothioates (mP₂S₅-nNa₂Sₓ) for Na Battery Chemistry

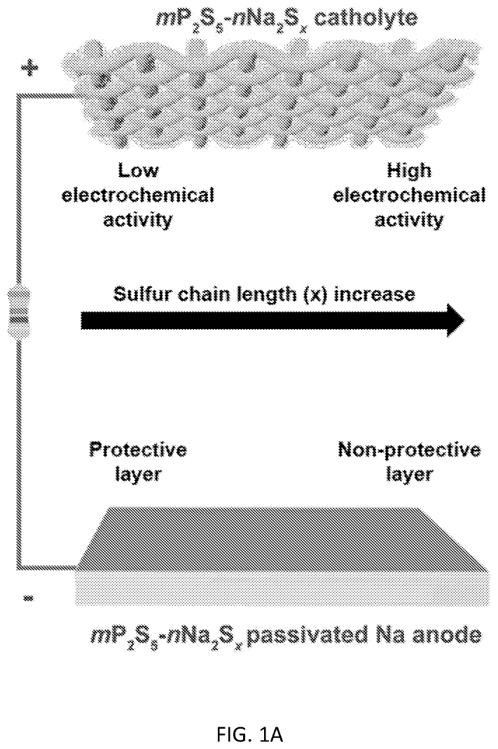

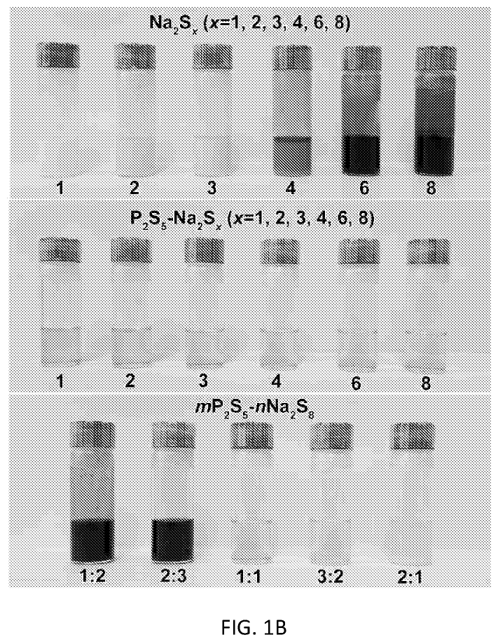

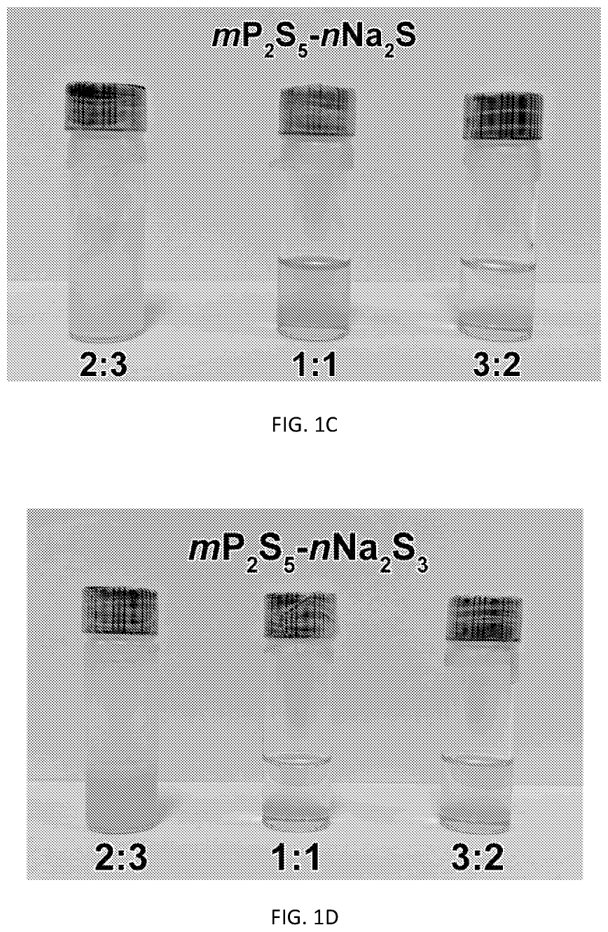

mP₂S₅-nNa₂Sₓ complexes were obtained through the reactions among precursors of sodium sulfide (Na₂S), sulfur (S) and phosphorous pentasulfide (P₂S₅) in diglyme solvent at room temperature, in which no external heating is required. This new family of complexes mP₂S₅-nNa₂Sₓcould be tailored in two dimensions: length of Sₓ chain (x) and the ratio of P₂S₅ to Na₂Sₓ (m:n), showing unique electrochemical characteristics for Na battery chemistry, which can contribute to the construction of a novel semi-solid Na battery (FIG. 1A). The battery configuration is illustrated in FIG. 1A, where the catholyte is stored in a current collector while metallic Na anode is protected with a solid electrolyte interphase (SEI) layer on the surface. It is found that, with respect to the catholyte side, longer S chain complexes possess highly interconnected structures, showing higher electrochemical reactivity compared to shorter S chain catholytes in relatively isolated status. Such longer S chain systems could be employed as high-capacity catholytes for Na batteries. Regarding the anode side, shorter S chain complexes could serve as passivation reagents to generate a uniform protective SEI on metallic Na anode, while the longer S chain ones inhomogeneously corrode the anode surface. Both longer and shorter S chain complexes show distinctive and irreplaceable functions, where combining a longer S chain catholyte and a shorter S chain pretreated Na anode creates novel Na battery chemistry showing superior electrochemical performance.

Various Sₓ chain length (x=1, 2, 3, 4, 6, 8) and P₂S₅ to Na₂Sₓ ratios (m:n=1:2, 2:3, 1:1, 3:2, 2:1) in mP₂S₅-nNa₂Sₓ are exemplified herein (FIGS. 1B, 1C, and 1D). It is noted that solid S alone cannot complex with P₂S₅ in diglyme solvent. The solid S needs to react with Na₂S to form Na₂Sₓ before complexing with P₂S₅. The differences between P₂S₅—Na₂Sₓ (x=1, 2, 3, 4, 6, 8) complexes and the corresponding Na₂Sₓ can be visually distinguished. Before reacting with P₂S₅, the appearance of Na₂Sₓvaries based on the length of the Sₓ chain. Shorter-chain Na₂Sₓ (x=1, 2, 3) are insoluble in diglyme; while, Na₂S₄ shows limited solubility and Na₂S₆/Na₂S₈ can be fully dissolved and exhibits a dark red brown color. Both insoluble and soluble Na₂Sₓ can complex with P₂S₅ to form transparent and homogeneous solutions. The colors of P₂S₅—Na₂Sₓ change from orange to light yellow and further to deep yellow with the increase of Sₓ chain lengths. When tailoring the P₂S₅ to Na₂Sₓ ratio m:n with a fixed x dimension (x=8) in mP₂S₅-nNa₂S₈ system (m:n=1:2, 2:3, 1:1, 3:2, 2:1) in FIG. 1B, homogeneous systems are formed in the ratio range from 2:3 to 3:2 with color showing as dark red, yellow and deeper yellow, respectively, while both 1:2 and 2:1 ratios result in nonhomogeneous systems (solids at the bottom of vials in FIG. 1B). The similar m:n ratio effect was also investigated and confirmed in mP₂S₅-nNa₂S and mP₂S₅-nNa₂S₃ (m:n=3:2, 1:1 and 2:3) systems (FIGS. 1C and 1D).

### Methods and Materials

New family complexes preparation: Sodium sulfide (Na₂S), phosphorous pentasulfide (P₂S₅) and sulfur (S) powder (Sigma-Aldrich) were used as starting materials to synthesize mP₂S₅-nNa₂Sₓ complexation systems. P₂S₅—Na₂Sₓ (x=1, 2, 3, 4, 6, 8) complexes were prepared in different stoichiometric ratios of Na₂S, S and P₂S₅ (in 1:x-1:1 molar ratio) in diethylene glycol dimethyl ether (diglyme, anhydrous, Sigma-Aldrich) solvent, which were stirred to form a solution without heating in a solid-to-liquid ratio of 20 wt %. Similar to the synthesis process of P₂S₅—Na₂Sₓcomplexes, Na₂Sₓ (x=1, 2, 3, 4, 6, 8) were obtained by mixing Na₂S and S powder (in 1:x-1 molar ratio) in diglyme with a solid-to-liquid ratio of 20 wt %. As to mP₂S₅-nNa₂S₈, precursors were calculated and mixed stoichiometrically to get m:n of 1:2, 2:3, 1:1, 3:2 and 2:1 in diglyme. The photo (FIG. 1B) shows the appearance of systems after same synthesis time around 1 to 2 hours. Same synthesis method was employed to mP₂S₅-nNa₂S and mP₂S₅-nNa₂S₃ (m:n=2:3, 1:1, 3:2) systems.

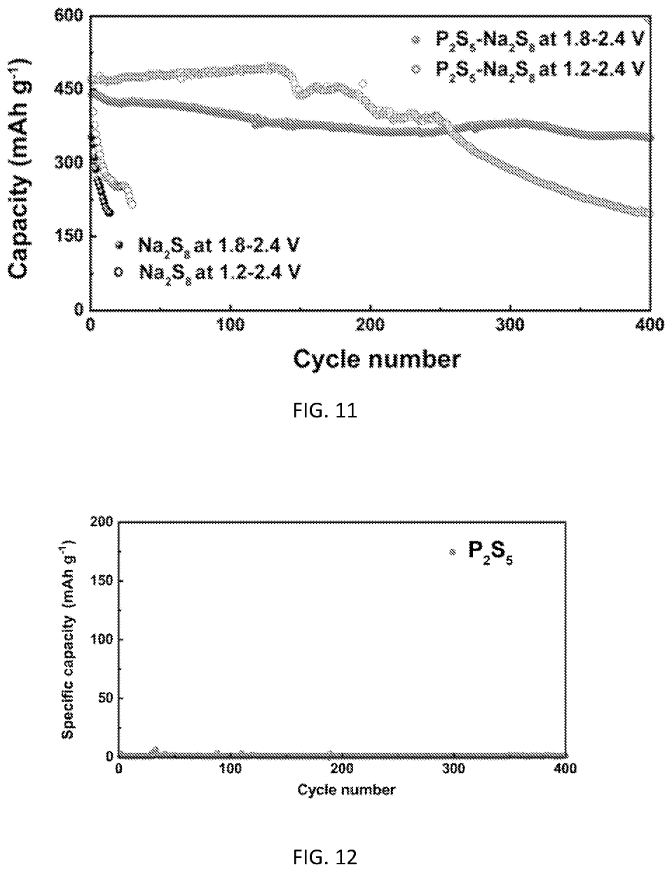

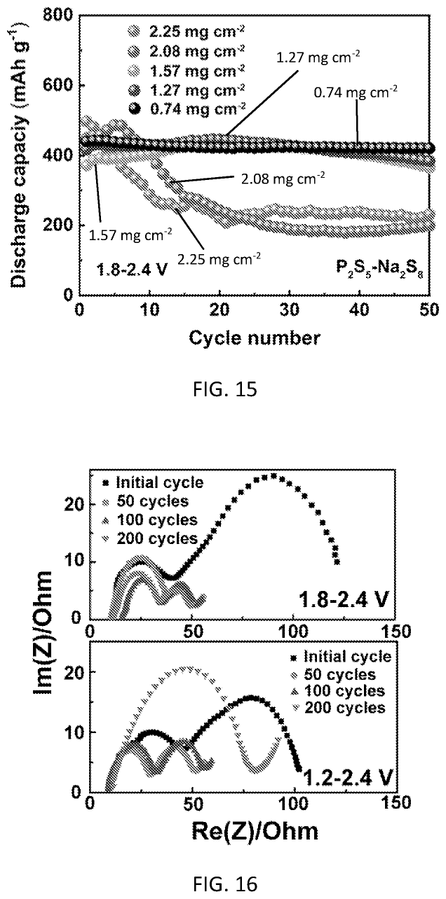

Catholyte preparation: P₂S₅—Na₂Sₓ, Na₂S₈ and P₂S₅ were mixed with 1 vol % Ketjen Black (AkzoNobel, EC-600JD) and 0.5 M sodium hexafluorophosphate (NaPF₆, Sigma-Aldrich, 98%) to prepare as catholytes. As-prepared catholytes (˜16 ul) were then dropped onto the commercial carbon fiber paper (FuelCellStore) disk with a diameter of 12 mm. In P₂S₅—Na₂Sₓ and Na₂S₈ catholytes, S concentrations (based on the S in Na₂Sₓ) were kept as around 1.44 M. The active material loading (based on the S content) is 0.74 mg cm⁻² in FIG. 11. Several other loadings, up to 2.25 mg cm ⁻², have been tested as shown in FIG. 15. As the control group of P₂S₅ suspension, the S concentration was based on S in P₂S₅ , where insoluble solids were well dispersed in diglyme.

Sodium metal anode passivation: Commercial sodium metal cube (Na, 99.9%, Sigma-Aldrich) was manufactured into Na foil with a diameter of 12 mm. The efficient agent used to stabilize Na foil was 10 wt % P₂S₅—Na₂Sₓ (x=1). Na foil was immersed in the passivation complex overnight. The control group of passivation solution is 10 wt % P₂S₅—Na₂Sₓ (x=8), which was used to prepare P₂S₅—Na₂S₈ passivated Na following the same procedure.

Electrochemical measurements: Electrochemical performance was tested in 2032-type coin cells assembled with as-prepared catholyte on carbon fiber paper (CFP), passivated Na metal anode and separator (Celgard 2400) soaked with electrolyte, which consisted of 1.0 M NaPF₆ in diglyme. The assembled batteries were galvanically charged and discharged at 0.5 C (1 C=1675 mA g⁻¹) at voltage range of 1.2-2.4 V and 1.8-2.4 V using standard testing system (CT 2001A, Wuhan LAND Electronics Co., Ltd). Electrochemical Impedance Spectroscopy (EIS) was performed using electrochemical workstation (VMP3, Biologic Science Instruments) at a scanning frequency from 900 KHz to 100 mHz. Cyclic voltammetry was performed using electrochemical workstation (VMP3, Biologic Science Instruments) at scanning rates of 0.1, 0.15 and 0.20 mV s⁻¹ at voltage range of 1.2-2.4 V and 1.8-2.4 V.

Materials characterizations: Scanning electron microscopy (SEM) and energy dispersive x-ray spectroscopy (EDS) were carried out using field emission gun environmental scanning electron microscope (XL 300 ESEM-FEG). Focus ion beam (FIB) was performed to reveal cross-section SEM image using FEI Scios2 LoVac dual beam FEG/FIB SEM. Laser Raman Spectroscopy (LRS) was measured using Horiba labRAM HR Evolution operating at wavelength of 532 nm, where double pass macro cuvette holder was used for solution analysis. Raman shifts were calibrated using silicone reference with a very sharp silicon mode at 520 cm⁻¹. ³¹P and ¹H Nuclear Magnetic Resonance (NMR) was carried out using Bruker 600 MHz Advance III HD with a 5 mm probe of Bruker BB(F)O. Chemical shifts in ³¹P NMR were calibrated to 85% phosphoric acid solution (H₃PO₄, δ=0 ppm). X-ray photoelectron spectroscopy (XPS) analysis was conducted on PHI Versaprobe II scanning XPS microprobe with 0.47 eV system resolution using monochromatic 1486.7 X-ray source. Notably, the samples were transferred into the XPS chamber via a sealed Argon-filled vessel to avoid the exposure to air.

### Example 2

### Characterizations of mP₂S₅-nNa₂Sₓ

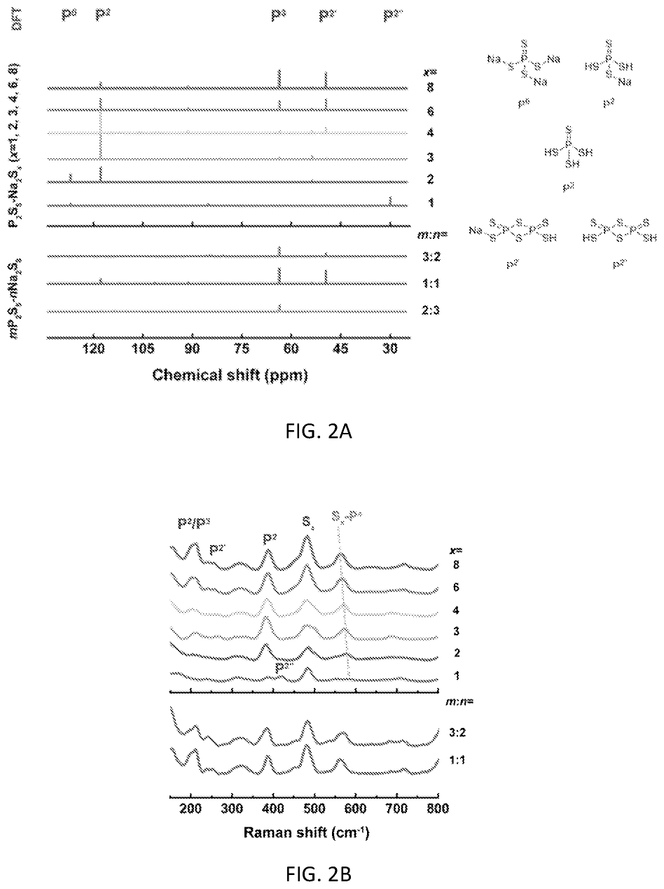

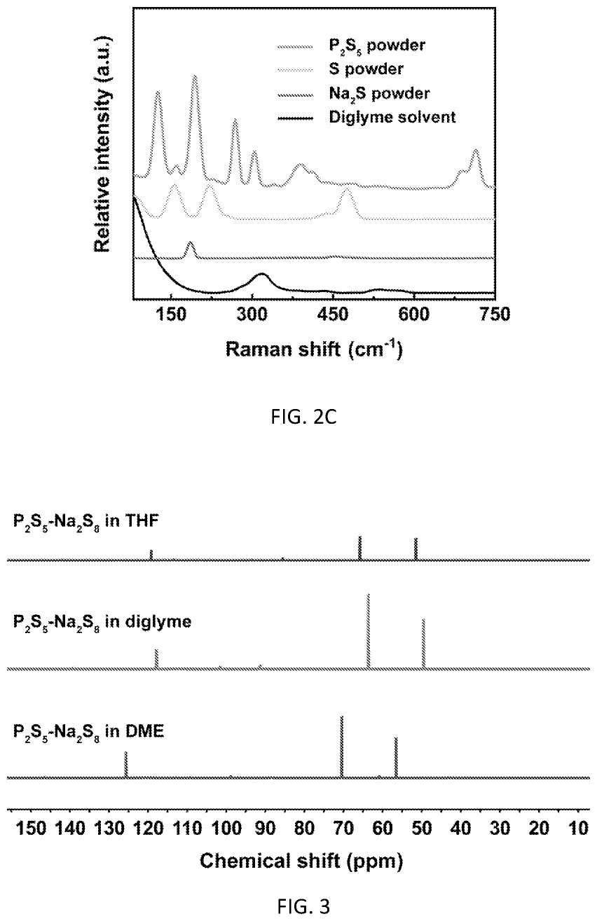

To facilitate in-depth understanding of the molecular structures, both nuclear magnetic resonance (NMR) spectroscopy and Laser Raman spectroscopy were performed for P₂S₅—Na₂Sₓ (x=1, 2, 3, 4, 6, 8) and mP₂S₅-nNa₂S₈ (m:n=3:2, 1:1 and 2:3), as shown in FIGS. 2A and 2B. The existence of P₂S₅ derivatives, known as Pⁿ short range orders (SROs), can be identified by ³¹P chemical shifts observed in NMR profiles. Pⁿ SRO denotes a P group with n number of bridging S atoms, across P₂S₅—Na₂Sₓ forming ranges, which have been discovered in glassy phosphorothioates solid-state materials.¹⁻⁶ It is noted that no P₂S₅ solution NMR profile is presented due to its insolubility in diglyme. ³¹P-NMR profiles of P₂S₅—Na₂Sₓ (x=1, 2, 3, 4, 6, 8) (FIG. 2A) solutions display 5 major distinctive chemical shifts. The signals at 49, 63, 118, 127 and 30 ppm are assigned to P²′, P³, P², P⁰ and P²″ (a derivative of P²′) SRO units, respectively.¹⁻⁶ All assignments were assigned based on density functional theory (DFT) and previous studies in literature. The spectroscopic data indicate that highly branched network structures are preferred for longer S chain system, while shorter S chain systems tend not to exhibit this property. As to mP₂S₅-nNa₂S₈ (m:n=3:2, 1:1, 2:3) systems, ³¹P-NMR results reveal the existence of P²′, P³ and P² SROs in P₂S₅—Na₂S₈, while P²NMR resonance disappears in 3P₂S₅-2Na₂S₈, possibly due to the interaction of excessive P₂S₅ with P² (linear connectivity) in forming P³ (network connectivity).¹⁻⁶ Nevertheless, NMR resonances are barely observed except for P³ in the 2P₂S₅-3Na₂S₈, which is possibly ascribed to the network connectivity destruction by excess Na₂S₈.

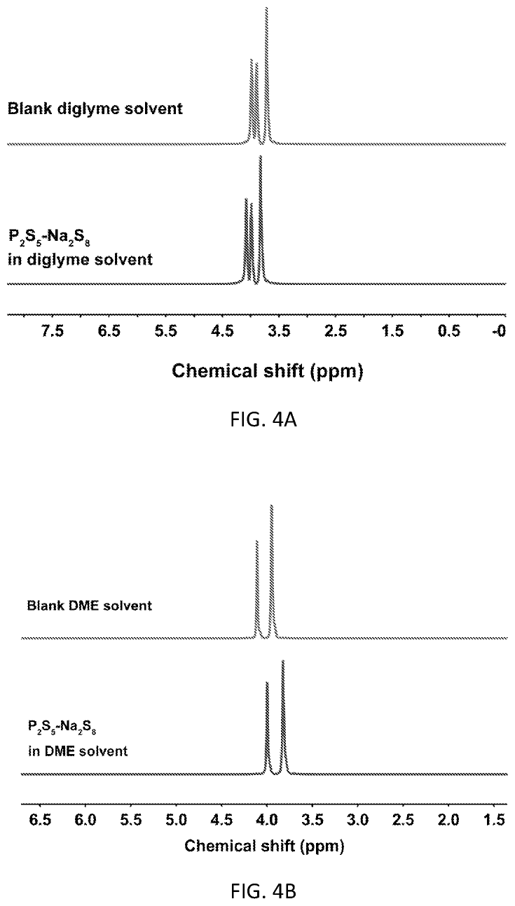

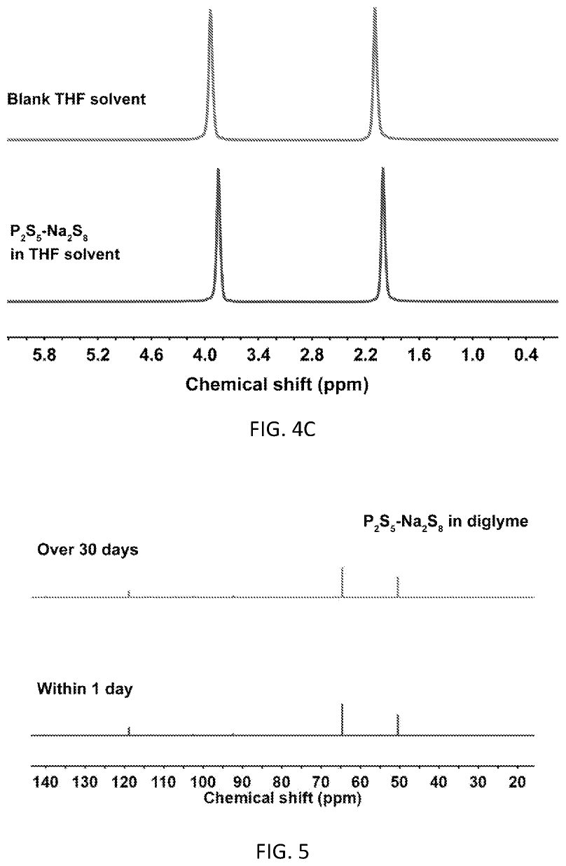

Raman profiles in FIG. 2B reveal chemical interactions among precursors of Na₂S, P₂S₅ and S during the complexation process. Before reaction, Na₂SₓP₂S₅ and S precursors show distinctive Raman shifts (FIG. 2C). After reaction, all characteristic peaks of precursors disappear while new peaks occur due to the formation of mP₂S₅-nNa₂Sₓ. Raman profile of P₂S₅—Na₂S shows both distinctive and similar shifts to those in P₂S₅—Na₂Sₓ (x=2, 3, 4, 6, 8), where the peaks at 388 and 418 cm⁻¹ indicate the presence of P²″ SRO while the peak at 482 cm⁻¹ is ascribed to the symmetric stretching modes of —S—S— between Pⁿ SROs.^{1, 7-14} In P₂S₅—Na₂Sₓ (x=2, 3, 4, 6, 8) profiles, the band at 200˜215 cm⁻¹ indicates the presence of P²/P³ SROs while peaks at 386 and 493 cm⁻¹ reveal the modes in P² SRO. Besides, the peak at 575 cm⁻¹, assigned to T₂ asymmetric stretching of tetrahedral structure in Pⁿ SROs,^{1, 7-14} presenting lower-energy Raman shift with the increase of Sₓ chain length, which indicates the vibrations of Pⁿ SROs are affected by the chain length.¹⁴ For P₂S₅—Na₂Sₓ (x=4, 6, 8), two more peaks at 239 and 258 cm⁻¹ are observed, which indicate the presence of P²′ SRO.^{1, 7-14} The observations in Raman profiles are consistent with NMR results, which together reveal the structure of P₂S₅—Na₂Sₓ as network connectivity of Pⁿ SROs with Sₓ in-between. As to mP₂S₅-nNa₂S₈ (m:n=3:2, 1:1) systems, similar Raman profiles are observed, while the intensity of 200˜215 cm⁻¹ band (P²/P³ SROs) decreases for 3P₂S₅-2Na₂S₈, which corresponds to the disappearance of P² SRO observed in corresponding NMR profiles. Besides diglyme, other solvents including dimethoxyethane (DME) and tetrahydrofuran (THF) were also evaluated to prepare P₂S₅—Na₂S₈. ³¹P-NMR profiles of P₂S₅—Na₂S₈ in three different solvents (FIG. 3) show three similar characteristic resonances with chemical shifts observed, indicating the existence of similar P₂S₅—Na₂S₈ complex in different solvents. It is noted that the chemical shifts in these three NMR profiles is due to the solvent effect, where the polarity of three solvents in ascending order is diglyme>THF>DME. ¹H-NMR profiles of P₂S₅—Na₂S₈ in diglyme, DME and THF along with corresponding blank solvents are shown, respectively, in FIGS. 4A, 4B, and 4C, which exclude any reactions between P₂S₅—Na₂S₈ and solvents.¹⁴ Also, the ³¹P-NMR spectrum (FIG. 5) shows the P₂S₅—Na₂S₈ complex to be stable after storage for 30 days in diglyme.

### Example 3

### Electrochemical Evaluation on Battery Chemistry

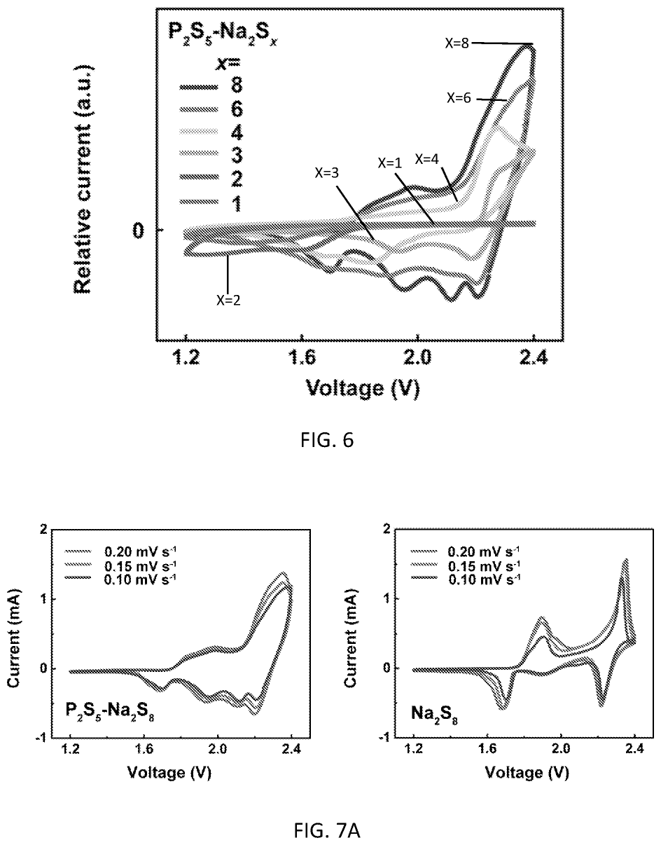

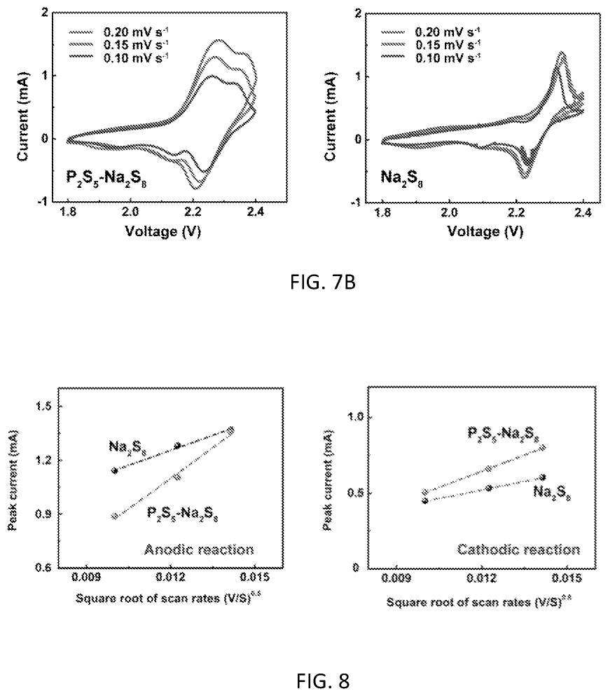

To demonstrate the relationship between chain length and reactivity, cyclic voltammetry (CV) was employed on the cells consisting of P₂S₅—Na₂Sₓ (x=1, 2, 3, 4, 6, 8) as catholyte and passivated Na metal as anode along with 1.0 M NaPF₆ in diglyme as electrolyte at a scan rate of 0.10 mV s⁻¹ within a voltage range of 1.2-2.4 V, as shown in FIG. 6. The preparation of catholyte, passivated anode and electrolyte as well as the cell configuration have been detailed in the experimental methods. In CV profiles, P₂S₅—Na₂S and P₂S₅—Na₂S₂, catholytes barely present any oxidation peaks, indicating no reversible electrochemical reactivity, while longer Sₓ chain P₂S₅—Na₂Sₓ (x=3, 4, 6, 8) show obvious oxidation and reduction peaks, which indicate the presence of reversible redox reactions. Noting that longer Sₓ chains possess higher electrochemical activity, P₂S₅—Na₂S₈ (the longest Sₓ chain in the family) was further investigated and compared with a traditional Na₂S₈ counterpart, where coin cells were assembled in the configuration of P₂S₅—Na₂S₈, Na₂S₈ and P₂S₅ as catholyte paired with passivated Na metal anode in 1.0 M NaPF₆ diglyme electrolyte. CV profiles of P₂S₅—Na₂S₈ reveal the same electrochemistry as that of Na₂S₈ (FIGS. 7A and 7B), where the CV profiles of P₂S₅—Na₂S₈ cells exhibits more pairs of redox peaks compared to those in Na₂S₈ cells, indicating that P₂S₅—Na₂S₈ possesses higher electrochemical kinetics and could anchor/stabilize intermediate polysulfide via Pⁿ units. The electrochemical kinetics is positively correlated to Na⁺ ion diffusion rate, which has been evaluated through CV measurements at different scan rates of 0.10, 0.15 and 0.20 mV s⁻¹ for both P₂S₅—Na₂S₈ and Na₂S₈ catholyte cells. According to classical Randles Sevcik equation, all cathodic and anodic peak currents are linear with the square root of scan rates, where the slopes of curves are positively correlated to the corresponding Na⁺ ion diffusion, plotted in FIG. 8.¹⁵ The higher Na⁺ ion diffusion rate of P₂S₅—Na₂S₈ reveals that the highly interconnected network structure could facilitate Na⁺ ion transfer, improving the kinetics of Na battery chemistry.

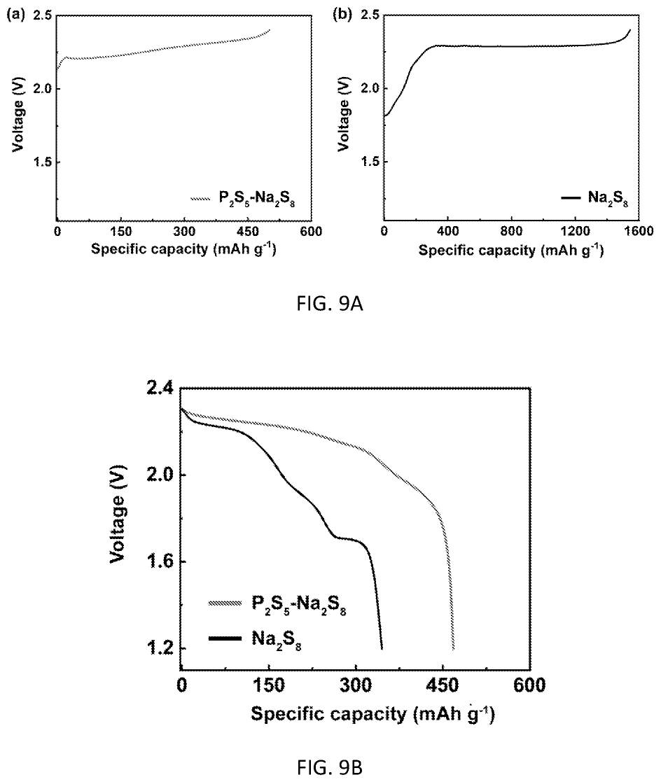

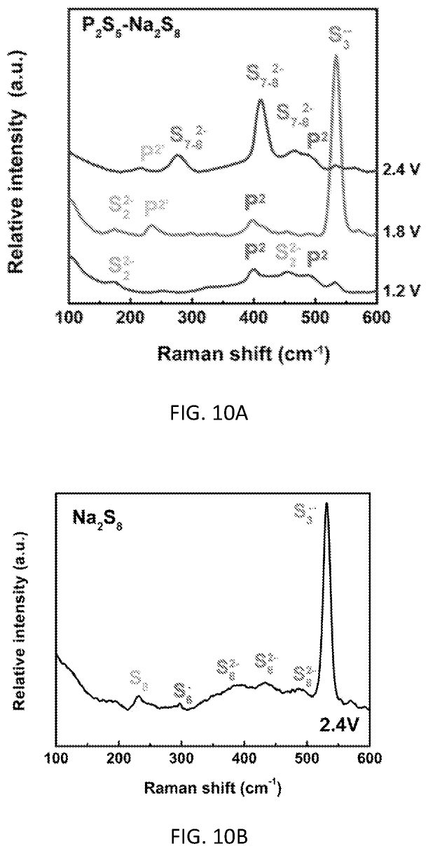

As revealed in the galvanostatic charge profiles (FIG. 9A), the Na₂S₈ catholyte shows a slow rise of charging voltage to ˜2.28 V. In contrast, the P₂S₅—Na₂S₈ catholyte exhibits a much faster voltage rise. The corresponding galvanostatic discharge profiles of P₂S₅—Na₂S₈ and Na₂S₈ catholyte cells at 1.2-2.4 V are presented in FIG. 9B, where P₂S₅—Na₂S₈ cells display both higher discharge electrochemical potentials and higher discharge capacity compared to those of Na₂S₈ cells, leading to higher specific energy delivery. The discharge curve of Na₂S₈ shows three plateaus at ˜2.23, 1.90 and 1.70 V, corresponding to the reduction peaks in CV profile, which reveals the electrochemical reactions from S₈ to Na₂S, in well consistent with previous reports. As to P₂S₅—Na₂S₈ catholyte cells, the discharge curve shows four plateaus, corresponding to CV reduction peaks at ˜2.23, 2.11, 1.93 and 1.70 V, which are assigned to the gradual reactions from S [symbol] ₋ [symbol] ²⁻ to S₂²⁻ species, confirmed in Raman (FIG. 10A). S [symbol] ₋ [symbol] ²⁻, S₃ [symbol] ⁻ and S₂²⁻ exhibit as the main products, excluding the formation of solid S at 2.4 V. In contrast, the Raman profile (FIG. 10B) of Na₂S₈ cells at 2.4 V indicates the presence of solid S and a great amount of untransformed S₃ [symbol] species, which confirms its low kinetic, leading to heavy residual of non-fully charged species. Another important observation in Raman is that P²′ trends to transform to P² at lower discharge potential, accommodating the low-solubility S₂²⁻ species into the network structure built upon Pⁿ SROs.

### Example 4

### Long-Term Cycling Evaluation on Catholyte Cells

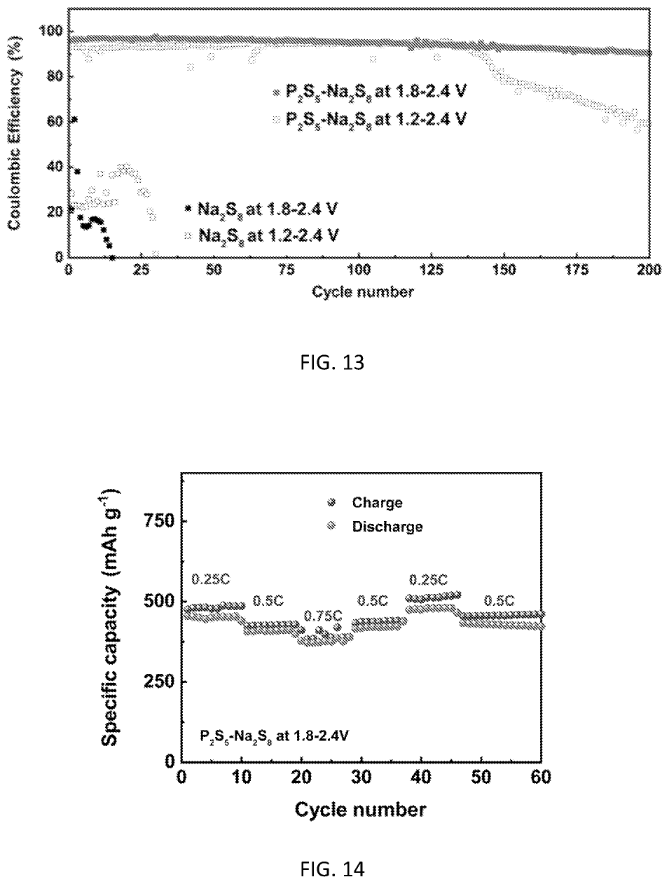

Galvanostatic cycling (FIG. 11) at 0.5 C (1 C=1675 mA g⁻¹) was performed at 2.4-1.8 V and 2.4-1.2 V to evaluate long-term electrochemical stability for battery chemistries using both P₂S₅—Na₂S₈ and Na₂S₈ catholytes. Mere P₂S₅ suspension as catholyte does not deliver any capacity (FIG. 12), which indicates that the electrochemical reactivity in P₂S₅—Na₂Sₓ catholyte is contributed by Sₓ from Na₂Sₓ. Despite voltage ranges, Na₂S₈ cells quickly decay due to both precipitation of low-order sodium polysulfide on the current collector and severe side reactions with anode, leading to poor Coulombic efficiency (FIG. 13). In contrast, P₂S₅—Na₂S₈ cells present good cycling stability and retention as well as high Coulombic efficiency at 1.8-2.4 V, where an initial capacity delivery of 440 mAh g¹ is achieved and a capacity of 352 mAh g⁻¹ can be retained even after over 400 cycles. The stable performance at different C-rates (FIG. 14) further demonstrates that P₂S₅—Na₂S₈ can serve as high performance catholyte. At higher active material loadings up to 1.57 mg cm⁻², P₂S₅—Na₂S₈ cells also exhibit steady cycling performance (FIG. 15). At very high loadings up to 2.25 mg cm⁻², where high complex concentrations were employed, an initial capacity decay was observed, possibly due to the parasitic reactions on sodium metal anodes. When operating within 1.2-2.4 V, the P₂S₅—Na₂S₈ cells deliver a higher initial capacity of 468 mAh g⁻¹ with a stable performance for about 130 cycles, and slowly decay after that.

To investigate the capacity decay mechanism of P₂S₅—Na₂S₈ cells cycled at 1.2-2.4 V, electrochemical impedance spectroscopy (EIS) of the P₂S₅—Na₂S₈ cells cycled at 0.5 C in 1.8-2.4 and 1.2-2.4 V were compared (FIG. 16). Nyquist plots (before cycling, after 50 cycles, and after 100 cycles) show two semi-circles, where the high-frequency semi-circle is attributed to the interfacial resistance/capacitance of the catholyte and the low-frequency semi-circle is ascribed to the charge-transfer resistance/pseudocapacitance of the catholyte.¹⁶ At the voltage range of 1.8-2.4 V, no obvious increment of impedance is observed over cycling, indicating good cycling reversibility and stability. As to the voltage range of 1.2-2.4 V, before 200 cycles, the impedance shows similar values as those at 1.8-2.4 V. However, the high-frequency semi-circle greatly increases after 200 cycles due to great accumulation of electrochemically inactive P₂S₅—Na₂S₂, which is hard to convert back to active P₂S₅—Na₂Sₓ (x=3, 4, 6, 8) species, leading to heavy increase of charge-transfer resistance.

No beneficial P interactions exist in the case of mere Na₂S₈ catholyte cells. Both P₂S₅—Na₂S₈ and Na₂S₈ cells performed within 1.8-2.4 V at 0.5 C for 30 cycles were dissembled and characterized to evaluate the contribution of P interactions to stabilize Na—S battery chemistry. The catholyte current collectors for P₂S₅—Na₂S₈ and Na₂S₈ cells after cycling were subjected to SEM and corresponding energy-dispersive X-ray spectroscopy (EDS) on C, Na and S elements. Compared to clean commercial carbon paper, the catholyte current collector dissembled from P₂S₅—Na₂S₈ cell showed a very similar clean matrix without solid precipitation observed, where Na and S elements could be detected, originating from the soluble species of P₂S₅—Na₂Sₓ. Nevertheless, the catholyte current collector dissembled from the Na₂S₈ cell displayed a great solid agglomeration of insoluble low-order sodium polysulfide, which explains the poor electrochemical performance of Na₂S₈ cells. The SEM and EDS results indicate that mere Na₂S₈ could lead to the formation of insoluble discharge products, while new molecules of P₂S₅—Na₂S₈ could accommodate the insoluble products within the network of P″ SROs, leading to superior electrochemical performance.

### Example 5

### Characterization on Passivated Na Over Cycling

The metallic Na anodes employed in the cells were pretreated before being paired with catholytes, using a passivation solution of P₂S₅—Na₂Sₓwhich generates a protective solid electrolyte interphase (SEI) layer on metallic Na surface. The surface and cross-section morphologies of P₂S₅—Na₂S passivated Na were analyzed and revealed nanostructured-petal cluster surface morphology with petal thickness of 500 nm and SEI with a thickness of 2 μm (outlined in the inset). Further x-ray photoelectron spectroscopy (XPS) of C₁ₛ, P₂ₚ and S₂ₚ profiles, in FIG. 18 unveil the compositions of passivation layer. The binding energies of all elements were calibrated with respect to C₁ₛ at 284.8 eV.¹⁷⁻¹⁹In C₁ₛ XPS profile, binding energy at 286.4 eV is assigned to C—O in RCH₂ONa, which is due to the decomposition of electrolyte.¹⁷⁻¹⁹ During XPS peak-fitting for P₂ₚ and S₂ₚ, 2p_{3/2} to 2p_{1/2} area ratio is fixed at 2:1 according to the ratio of degeneracy. The doublet separation of 2p_{3/2} and 2p_{1/2} for P₂ₚ is 0.87 eV while the one for S₂ₚ is 1.18 eV. The high-resolution P₂ₚ XPS spectrum exhibits three doublets, at 132.01, 132.92 and 133.74 eV (based on the 2p_{3/2}), respectively, ascribed to the presence of P^{1P}, P¹ and P⁰ SROs.^{14, 20-22} The high-resolution of S₂ₚ XPS presents three doublets, at 161.49, 162.17 and 162.99 eV (based on the 2p_{3/2}), respectively, assigned to Na—S—P, P═S and P—S—P in Pⁿ SROs, which are in well consistent with results of P₂ₚ XPS.^{14, 20-22} Paired with such passivated Na, Na₂S₈ catholyte cells show poor electrochemical performance, while the P₂S₅—Na₂S₈ cells demonstrate superior stability.

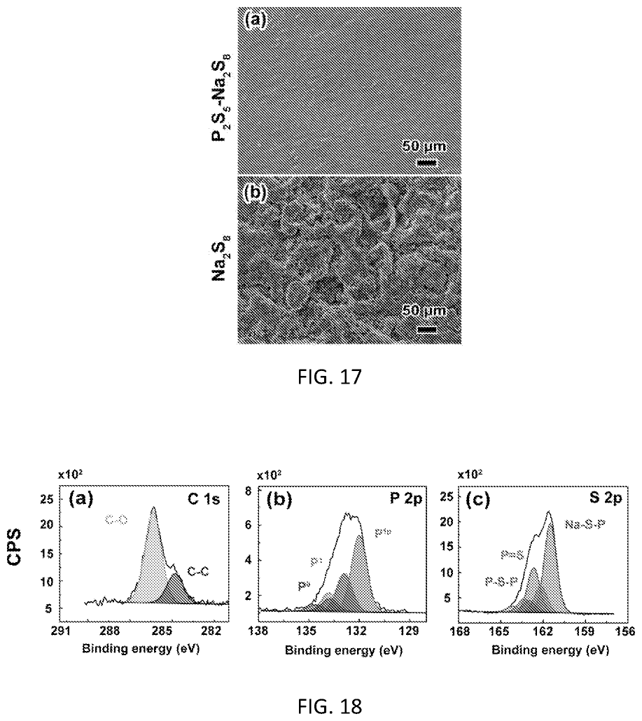

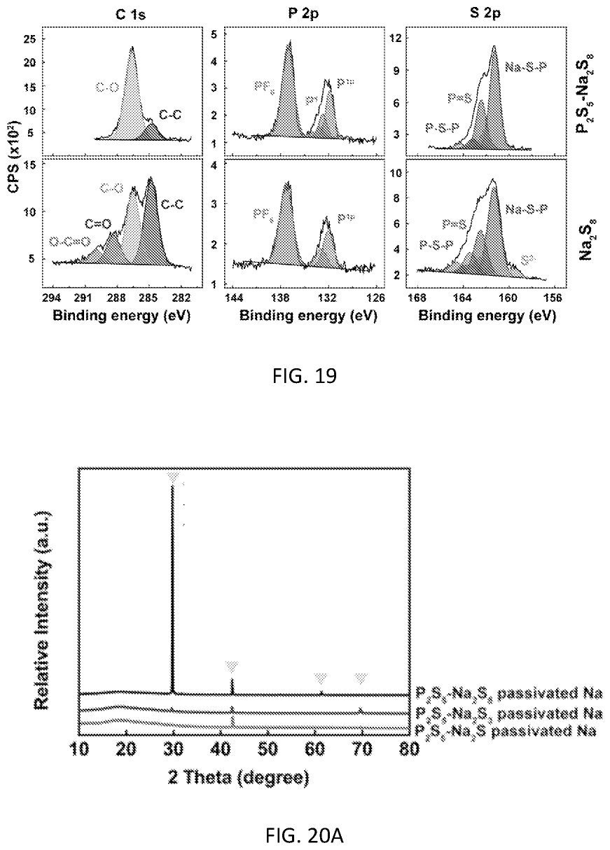

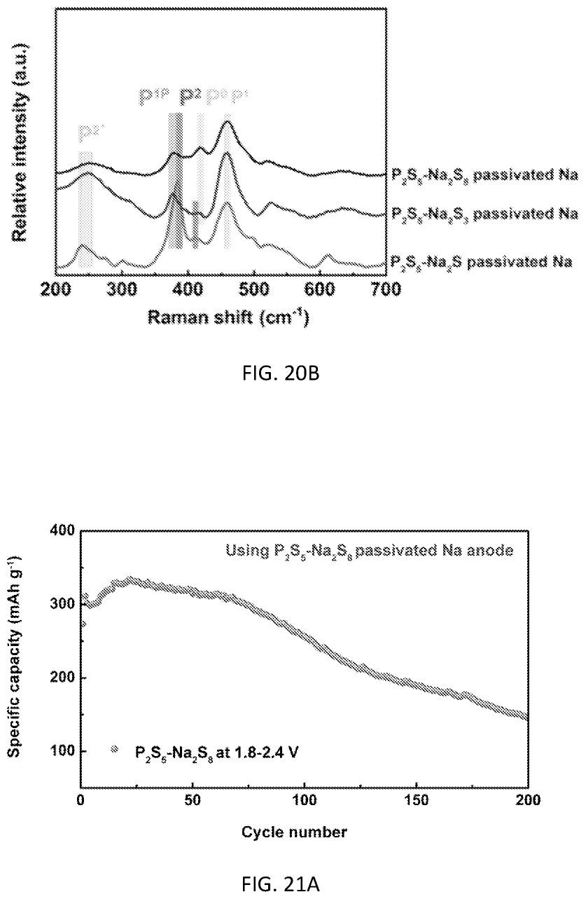

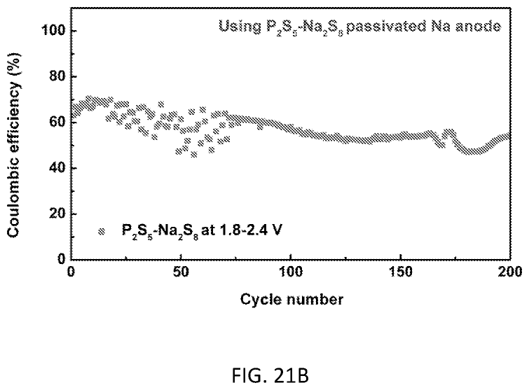

To explain the difference, the passivated Na surfaces from dissembled P₂S₅—Na₂S₈ and Na₂S₈ cells after 30 cycles were characterized via SEM and corresponding XPS, shown in FIGS. 17 and 19. The passivated Na from P₂S₅—Na₂S₈ cells and from Na₂S₈ cells (FIG. 17) show different surface morphology after cycling, where the P₂S₅—Na₂S₈ cells display a smooth surface while the Na₂S₈ cells exhibit gully-like topography due to severe side-reactions. Additionally, shown in FIG. 19, C₁ₛ and S₂ₚ XPS of passivated Na for P₂S₅—Na₂S₈ cells after cycling show similar profiles to those before cycling, while P⁰ disappears in the P₂ₚ XPS profile with appearance of —PF₆ (137.29 eV),¹⁷⁻¹⁹ which is due to the stabilization of the passivation layer and to the decomposition of NaPF₆ salt, respectively. Nevertheless, the passivated Na from Na₂S₈ cells after cycling shows tremendously different C₁ₛ, P₂ₚ and S₂ₚ XPS profiles. In addition to C—C and C—O, C═O (288.34 eV) and O—C═O (289.93 eV)¹⁷⁻¹⁹ are detected, which are possibly due to the reaction of fresh Na with electrolyte after the original protection layer is etched and destroyed by Na₂S₈. The severe side reactions of Na₂S₈ with original passivation layer is confirmed by the disappearance of both P⁰ and P¹ in P₂ₚ XPS profile as well as the presence of S²⁻ (159.52 eV) doublet^{17, 18} detected in S₂ₚ XPS. The SEM and XPS results indicate that mere Na₂S₈ could heavily react with the original P₂S₅—Na₂S passivation layer on the anode, while P₂S₅—Na₂S₈ could stabilize the original passivation layer, showing good compatibility. The formation of robust SEI using short S chain P₂S₅—Na₂S is unique and due to chemical reactions between P₂S₅—Na₂S and metallic Na. P₂S₅—Na₂S₃ and P₂S₅—Na₂S₈ were selected from the P₂S₅—Na₂Sₓ family and evaluated due to the presence of different S valence compared to that (−2) in P₂S₅—Na₂S. Both candidates showed aggressive reactions with Na metal, leading to porous and ravined surface morphology. With higher S valence, P₂S₅—Na₂S₈ passivation solution showed even more severe side reactions compared to P₂S₅—Na₂S₃ one. It is noted that all SEI layers via three passivation solutions show similar amorphous phase and compositions (FIGS. 20A and 20B). Besides Na₄P₂S₇, Na₄P₂S₆, Na₂P₂S₆ and Na₃PS₄ compounds, the SEI layer of P₂S₅—Na₂S passivated Na mainly contains NaPS₃, which is not a main component detected in SEI layers of P₂S₅—Na₂S₃ and P₂S₅—Na₂S₈ passivated Na. Such NaPS₃ compound is compatible with long S chain P₂S₅—Na₂S₈ catholyte, leading to stable battery chemistry realization. In contrast, pairing with P₂S₅—Na₂S₈ passivated Na metal anode without NaPS₃ component, P₂S₅—Na₂S₈ catholyte cells show poor cycling performance with low Coulombic efficiency (FIGS. 21A and 21B), due to geographical inhomogeneity and chemical incompatibility of SEI generated using high S chain P₂S₅—Na₂Sₓcomplexes.

### REFERENCES

All references cited in this disclosure, including patents, patent applications, scientific papers and other publications, are hereby incorporated by reference into this application.
[1] Bischoff, C., Schuller, K., Haynes, M., & Martin, S. W. Structural investigations of yNa₂S+(1−y) PS_{5/2} glasses using Raman and infrared spectroscopies. J. Non-Cryst. Solids 358, 3216-3222 (2012).
[2] Larink, D., Ren, J., & Eckert, H. Spectral editing based on scalar spin-spin interactions: New results on the structure of metathiphosphate glasses. Solid State Nucl. Magn. Reson. 45, 30-35 (2012).
[3] Bischoff, C., Schuller, K., Dunlap, N. & Martin, S. W. I R, Raman, and NMR studies of the short-range structure of 0.5Na₂S+0.5[xGeS₂+(1−x) PS_{5/2}] mixed glass-former glasses. J. Phys. Chem. B 118, 1943-1953 (2014).
[4] Watson, D. E. & Martin, S. W. Structural characterization of the short-range order in high alkali content sodium thiosilicophosphate glasses. Inorg. Chem. 57, 72-81 (2018).
[5] Seino, Y. et al. Analysis of the structure and degree of crystallization of 70Li₂S-30P₂S₅ glass ceramic. J. Mater. Chem. A 3, 2756-2761 (2015).
[6] Dietrich, C., et al. Synthesis, structural characterization, and Lithium ion conductivity of the Lithium thioposphate Li₂P₂S₆. Inorg. Chem. 56, 6681-6687 (2017).
[7] Berbano, S. S., Seo, I., Bischoff, C. M., Schuller, K. E. & Martin, S. W. Formation and structure of Na₂S+P₂S₅ amorphous materials prepared by melt-quenching and mechanical milling. J. Non-Cryst. Solids 358, 93-98 (2012).
[8] Wu, H. L., Huff, L. A. & Gewirth, A. A. In Situ Raman Spectroscopy of Sulfur Speciation in Lithium-Sulfur Batteries. ACS Appl. Mater. Interfaces 7, 1709-1719 (2015).
[9] Hagen, M., et al. In-situ Raman investigation of polysulfide formation in Li—S cells. J. Electrochem. Soc. 160, A1205-A1214 (2013).
[10] Janz, G. J. et al. Raman studies of sulfur-containing anions in inorganic polysulfide. Sodium polysulfide. Inorg. Chem. 15, 1759-1763 (1976).
[11] Jaroudi, O. E., Picquenard, E., Demortier, A., Lelieur, J. P. & Corset, J. Polysulfide anions II: structure and vibrational spectra of S⁴⁻ and S⁵⁻ anions. Influence of the cations on bond length, valence, and torsion angle. Inorg. Chem. 39, 2593-2603 (2000).
[12] Daly, F. P. & Brown, C. W. Raman spectra of sodium tetrasulfide in primary amines. Evidence for S⁴⁻ and S₈ⁿ⁻ in rhombic sulfur-amine solutions. J. Phys. Chem. 79, 350-354 (1975).
[13] Jaroudi, O. E., Picquenard, E., Gobeltz, N., Demortier, A. & Corset, J. Raman spectroscopy study of the reaction between sodium sulfide or disulfide and sulfur: Identify of the species formed in solid and liquid phases. Inorg. Chem. 38, 2917-2923 (1999).
[14] Pang, Q., Liang, X., Shyamsunder, A., & Nazar, L. F. An in vivo formed solid electrolyte surface layer enables stable plating of Li metal. Joule 1, 1-16 (2017).
[15] Tao, X. et al. Balancing surface adsorption and diffusion of lithium-polysulfides on nonconductive oxides for lithium-sulfur battery design. Nat. Commun. 7, 11203 (2016)
[16] Chen, H., et al. Sulphur-impregnated flow cathode to enable high-energy-density lithium flow batteries. Nat. Commun. 6, 5877 (2015).
[17] Wang, H., Wang, C., Matios, E. & Li, W. Facile stabilization of sodium metal anode with additives: Unexpected key role of sodium polysulfide and adverse effect of sodium nitrate. Angew. Chem. 57, 1-5 (2018).
[18] Li, W. et al. The synergetic effect of lithium polysulfide and lithium nitrate to prevent lithium dendrite growth. Nat. Commun. 6, 7436 (2015).
[19] Seh, Z. W., Sun, J., Sun, Y. & Cui, Y. A Highly Reversible Room-Temperature Sodium Metal Anode. ACS Cent. Sci. 1, 449-455 (2015).
[20] Busche, M. R. et al. In Situ Monitoring of Fast Li-Ion Conductor Li₇P₃S₁₁ Crystallization Inside a Hot-Press Setup. Chem. Mater. 28, 6152-6165 (2016).
[21] Wenzel, S. Thermodynamic and kinetic instability of inorganic solid electrolytes at lithium and sodium metal electrodes. (2016)
[22] Chi, X., et al. Tailored organic electrode material compatible with sulfide electrolyte for stable all-solid-state sodium batteries. Angew. Chem. 130, 2660-2664 (2018).

We claim:

1. A metal (M)-sulfur battery comprising:
a cathode comprising an mP₂S₅-nM₂Sₓ complex;
an anode comprising the metal, wherein the metal is passivated using an anode passivation solution comprising an aP₂S₅-bM₂S_{y} complex; and
an electrolyte in contact with the cathode and the anode;
wherein the metal (M) is lithium or sodium;
wherein the ratio of P₂S₅ to M₂Sₓ (m:n) in the cathode is between 1:2 and 2:1, optionally the ratio of P₂S₅ to M₂Sₓ (m:n) in the cathode is 1:2, 2:3, 1:1, 3:2, or 2:1;
wherein the ratio of P₂S₅ to M₂S_{y} (a:b) in the anode passivation solution is between 1:2 and 2:1, optionally the ratio of P₂S₅ to M₂S_{y} (a:b) in the anode passivation solution is 1:2, 2:3, 1:1, 3:2, or 2:1; and
wherein x and y are independently an integer from 1 to 12.

2. The battery of claim 1, wherein M is sodium.

3. The battery of claim 1, wherein m:n is 1:1.

4. The battery of claim 1, wherein a:b is 1:1.

5. The battery of claim 1, wherein x is 8.

6. The battery of claim 1, wherein y is 1.

7. The battery of claim 1, wherein the battery further comprises a solid electrolyte interphase (SEI) on the anode, wherein the SEI mainly comprises Na₄P₂S₇, Na₄P₂S₆, Na₂P₂S₆, Na₃PS₄ and NaPS₃.

8. The battery of claim 1, wherein the electrolyte comprises NaPF₆ in diglyme.

9. The battery of claim 1, further comprising a separator, wherein the separator keeps the cathode and the anode apart.

10. The battery of claim 1, wherein the battery is rechargeable.

11. The battery of claim 1, wherein the cathode is a liquid-phase cathode.

12. A metal (M)-sulfur cell comprising:
a cathode comprising an mP₂S₅-nM₂Sₓ complex;
an anode comprising the metal, wherein the metal is passivated using an anode passivation solution comprising an aP₂S₅-bM₂S_{y} complex; and
an electrolyte in contact with the cathode and the anode;
wherein the metal (M) is lithium or sodium;
wherein the ratio of P₂S₅ to M₂Sₓ (m:n) in the cathode is between 1:2 and 2:1, optionally the ratio of P₂S₅ to M₂Sₓ (m:n) in the cathode is 1:2, 2:3, 1:1, 3:2, or 2:1;
wherein the ratio of P₂S₅ to M₂S_{y} (a:b) in the anode passivation solution is between 1:2 and 2:1, optionally the ratio of P₂S₅ to M₂S_{y} (a:b) in the anode passivation solution is 1:2, 2:3, 1:1, 3:2, or 2:1; and
wherein x and y are independently an integer from 1 to 12.

13. A method of manufacturing the metal (M)-sulfur cell of claim 12 comprising
mixing a first stoichiometric ratio of metal sulfide (M₂S), phosphorous pentasulfide (P₂S₅) and sulfur (S) powder in a first organic solvent to form the aP₂S₅-bM₂S_{y} complex;
contacting a metal foil with the aP₂S₅-bM₂S_{y} complex to form the passivated anode;
mixing a second stoichiometric ratio of metal sulfide (M₂S), phosphorous pentasulfide (P₂S₅) and sulfur (S) powder in a second organic solvent to form the mP₂S₅-nM₂Sₓcomplex;
mixing the mP₂S₅-nM₂Sₓ complex with electro-conductive carbon black and a salt to form the cathode; and
contacting the electrolyte with the passivated anode and the cathode.

14. The method of claim 13, wherein the aP₂S₅-bM₂S_{y} complex is formed by
mixing the metal sulfide (M₂S) and the sulfur (S) powder in the first organic solvent to provide a metal polysulfide (M₂S_{y}); and
combining the metal polysulfide (M₂S_{y}) with the phosphorous pentasulfide (P₂S₅) to form the aP₂S₅-bM₂S_{y} complex.

15. The method of claim 13, wherein the aP₂S₅-bM₂S_{y} complex is formed via a one-step reaction by mixing the first stoichiometric ratio of the metal sulfide (M₂S), the phosphorous pentasulfide (P₂S₅), and the sulfur (S) powder in the first organic solvent.

16. The method of claim 13, wherein the mP₂S₅-nM₂Sₓ complex is formed by
mixing the metal sulfide (M₂S) and the sulfur (S) powder in the second organic solvent to provide a metal polysulfide (M₂Sₓ); and
combining the metal polysulfide (M₂Sₓ) with the phosphorous pentasulfide (P₂S₅) to form the mP₂S₅-nM₂Sₓcomplex.

17. The method of claim 13, wherein the mP₂S₅-nM₂Sₓcomplex is formed via a one-step reaction by mixing the second stoichiometric ratio of the metal sulfide (M₂S), the phosphorous pentasulfide (P₂S₅), and the sulfur (S) powder in the second organic solvent.

18. The method of any one of claim 13, wherein the first organic solvent and the second organic solvent are the same.

19. The method of claim 13, wherein the first and second organic solvents comprise diethylene glycol dimethyl ether (diglyme), 1,2-dimethoxyethane (DME), tetrahydrofuran (THF), 1,3-dioxolane (DOL), tetraethylene glycol dimethyl ether, or a combination thereof.

20. The method of claim 13, wherein the aP₂S₅-bM₂S_{y} complex and the mP₂S₅-nM₂Sₓ complex are formed at room temperature.

21. A metal phosphorothioate having the formula of cP₂S₅-dM₂S_{z}, wherein
the metal (M) is lithium or sodium;
the ratio of P₂S₅ to M₂S_{z} (c:d) is between 1:2 and 2:1, optionally the ratio of P₂S₅ to M₂S_{z} (c:d) is 1:2, 2:3, 1:1, 3:2, or 2:1; and
z is an integer from 1 to 12.

22. The metal phosphorothioate of claim 21, wherein the metal is sodium.

23. The metal phosphorothioate of claim 21, wherein c:d is 1:1.

24. The metal phosphorothioate of claim 21, wherein z is 8.

25. The metal phosphorothioate of claim 21, wherein z is 1.

26. A method of preparing the metal phosphorothioate of claim 21 comprising:
mixing a stoichiometric ratio of metal sulfide (M₂S), phosphorous pentasulfide (P₂S₅) and sulfur (S) powder in an organic solvent.

27. The method of claim 26, wherein the cP₂S₅-dM₂S_{z} complex is formed by
mixing the metal sulfide (M₂S) and the sulfur (S) powder in the organic solvent to provide a metal polysulfide (M₂S_{y}); and
combining the metal polysulfide (M₂S_{y}) with the phosphorous pentasulfide (P₂S₅) to form the cP₂S₅-dM₂S_{z} complex.

28. The method of claim 26, wherein the cP₂S₅-dM₂S_{z} complex is formed via a one-step reaction by mixing the stoichiometric ratio of the metal sulfide (M₂S), the phosphorous pentasulfide (P₂S₅), and the sulfur (S) powder in the organic solvent.

29. The method of claim 26, wherein the organic solvent is diglyme.

30. The method of claim 26, wherein the metal phosphorothioate is prepared at room temperature.
